(19) United States
(12) Patent Application Publication
(10) Pub. No.: US 2006/0066121 A1
(43) Pub. Date: Mar. 30, 2006

(54) Adjustable ladder for pickup trucks

(76) Inventor: Joseph Derosier, Parkman, ME (US)

Correspondence Address: Raymond M. Galasso;Galasso & Associates LP, Suite 107, 115 Wild Basin Road, Austin, TX, 78746, US

(21) Appl. No.: 11/058,573

(22) Filed: Feb. 15, 2005

Related U.S. Application Data
(60) Provisional application No. 60/613,546, filed on Sep. 27, 2004.

(51) Int. Cl. B62D 33/023

(52) U.S. Cl. 296/62

(57) ABSTRACT

An adjustable ladder for pickup trucks is provided with rubber boots for secure traction. In an embodiment for getting into or out of a pickup bed, hinge mounts on one end attach to the inside of the tailgate of the pickup. When the tailgate is opened, the ladder unfolds in sections with lock pins and locking joints, the sections providing rungs. When not in use, the ladder folds together into a square formed by the sections, for convenient storage against the closed tailgate. In another embodiment for getting into or out of a pickup cab, a frame with tracks and rounded ends is mounted under a cab seat. A cab slide-out ladder slides within the frame to either side of the cab, hangs down from the curved ends, and extends to the ground. When the ladder is not in use, the cab slide-out ladder slides back into the frame.

### CROSS REFERENCE TO RELATED APPLICATIONS

This patent application claims priority to co-pending U.S. Provisional Patent Application having Ser. No. 60/613,546, filed on Sep. 27, 2004, entitled “E.Z. Step”, having a common applicant herewith and being incorporated herein in its entirety by reference.

### FIELD OF THE DISCLOSURE

The present invention relates to ladders, and more particularly, to ladders used to make areas of vehicles such as pickup trucks easier to get into and out of.

### BACKGROUND

Those who own and operate vehicles such as pickup trucks often require options that assist in making these vehicles easier and safer to operate as well as more comfortable to ride in. For example, pickup trucks with raised chassis are typically a challenge for users to get into and out of because the cab and the pickup bed in the back are raised higher off the ground than is usual for many other types of vehicles. Users who must climb unusually high to get into the cab or bed of a pickup truck with a raised chassis are at risk of suffering discomfort or injury.

As a result, some users may have to resort to different methods of getting into such pickup trucks. Some people stand on stools, chairs, curbs or other ad hoc devices to get into pickups, but these devices may not always be safe, effective, or readily available. Such devices may be unsteady or not of the right height to make getting into and out of pickups comfortable and safe. Moreover, these devices may not be able to be stored conveniently in the pickups for use anywhere that users may need the devices. For these and similar reasons, attempts have been made to design mechanical devices for many types of vehicles to facilitate access, in designs applicable to pickup trucks.

For example, U.S. Pat. No. 4,679,810 for Kimball provides a step assembly swingably mounted to a vehicle at a point forward of the seat. A control plate of the step assembly is swingably positioned by a powered actuating device. First and second steps are raised and lowered simultaneously by the control plate and in their lowermost position provide step access to the vehicle seat while in an elevated position provide a footrest for a seated operator. Pairs of links interconnect the steps. An additional pair of links connects the control plate to one of the steps. A pair of control bars is attached to and braces the forward most step and the vehicle body. A fully retracted position of the step assembly swings the control plate forwardly U.S. Pat. No. 5,697,626 for McDaniel provides a running board for an overland vehicle including first and second bell cranks with swing arms which move relative to the vehicle in opposing arcuate displacements. An elongated central running board member is flexibly connected to the swing arms to form a linkage which is extended and retracted. An extension compensator is included to compensate for changes in the overall length of the linkage. A motor-powered drive pivots the swing arms and preferably provides a control mechanism which coordinates the swing arm motions to keep the running board level. The drive can be automatically controlled by a door switch or other sensor.

However, prior techniques such as the ones given above are typically complicated assemblies of technology, often motor powered, which may make them expensive and difficult to use.

Therefore there is a need for an apparatus that provides a method of getting into vehicles, such as pickup trucks with raised chassis, that is safe, comfortable, simple in design, and that fits easily into the vehicles so that the device can potentially be used anywhere and at any time.

### SUMMARY OF THE DISCLOSURE

The following explanation describes the present invention by way of example and not by way of limitation.

It is an aspect of the present invention to provide an apparatus that makes it easier to get into pickup trucks with raised chassis.

It is an aspect of the present invention to provide an apparatus that makes it easier to get into pickup trucks with raised chassis and that is safe to use.

It is an aspect of the present invention to provide an apparatus that makes it easier to get into pickup trucks with raised chassis and that is simple in design.

It is an aspect of the present invention to provide an apparatus that makes it easier to get into pickup trucks with raised chassis and that is comfortable to use.

It is an aspect of the present invention to provide an apparatus that makes it easier to get into pickup trucks with raised chassis and that fits easily into a pickup truck so that the device can potentially be used anywhere and at any time.

These and other aspects, features, and advantages are achieved according to the present invention.

In accordance with the present invention, an adjustable ladder for pickup trucks is provided with rubber boots for secure traction. In an embodiment for getting into or out of a pickup bed, hinge mounts on one end attach to the inside of the tailgate of the pickup. When the tailgate is opened, the ladder unfolds in sections with lock pins and locking joints, the sections providing rungs. When not in use, the ladder folds together into a square formed by the sections, for convenient storage against the closed tailgate. In another embodiment for getting into or out of a pickup cab, a frame with tracks and rounded ends is mounted under a cab seat. A cab slide-out ladder slides within the frame to either side of the cab, hangs down from the curved ends, and extends to the ground. When the ladder is not in use, the cab slide-out ladder slides back into the frame.

These and other embodiments of the present invention will become readily apparent upon further review of the following specification and associated drawings.

### BRIEF DESCRIPTION OF THE DRAWINGS

The following embodiments of the present invention are described by way of example only, with reference to the accompanying drawings, in which:

FIG. 1 illustrates a three quarters view of an adjustable ladder that provides access to the bed of a pickup truck;

FIG. 2 illustrates a side view of an adjustable ladder that provides access to the bed of a pickup truck;

FIG. 3 illustrates a three quarters view of an adjustable ladder that provides access to the cab of a pickup truck; and

FIG. 4 illustrates a three quarters view of the slide out section of an adjustable ladder that provides access to the cab of a pickup truck.

### DETAILED DESCRIPTION OF THE DRAWINGS

The following description of drawings is offered to illustrate the present invention clearly. However, it will be apparent to those skilled in the art that the concepts of present invention are not limited to these specific details. Commonly known elements are also shown in diagrams for clarity, as examples and not as limitations of the present invention.

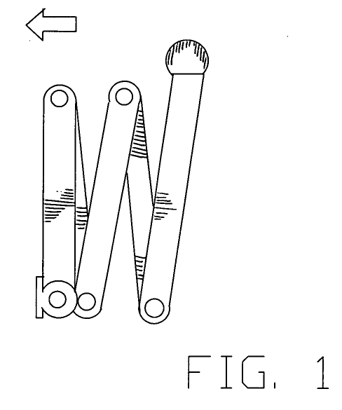

FIG. 1 illustrates a three quarters view of a folding tailgate ladder 10 that provides access to the bed of a pickup truck. In an embodiment, two hinge mounts 12, each with four chrome bolts and nuts are provided on one end, so that the ladder 10 may be attached securely into place on the inside of the tailgate of a pickup, typically on the right side, middle, or left side of the tailgate as the user may desire. In an embodiment, the bolts may be ½ inch round chrome bolts, and the nuts may be square metal nuts ½ inch in height and ½ inch in width.

When the tailgate is opened fully outwards, sections of the ladder 10 may be unfolded manually so that the ladder 10 extends to the ground. The sections of the ladder 10 comprise frame pieces 11 that are joined to rungs 13 by means of spring-loaded locking joints 14 with lock pins 16. In an embodiment, the frame pieces 11 may comprise metal tubing 2 inches in width, 1 inch in depth, and 19 inches in length with rounded ends. In an embodiment, the rungs 13 may comprise metal rods 1 inch in diameter and 11 inches in length. Rubber boots 18 on the two tips of the lower end of the folding tailgate ladder 10 provide secure traction.

The lock pins 16 serve to securely lock the locking joints 14 when the sections of the folding tailgate ladder 10 are folded up for storage and to unlock the locking joints 14 for unfolding the sections for use.

Different embodiments of folding tailgate ladder 10 may be of different total lengths, depending on the dimensions of the pickup trucks they are designed to fit.

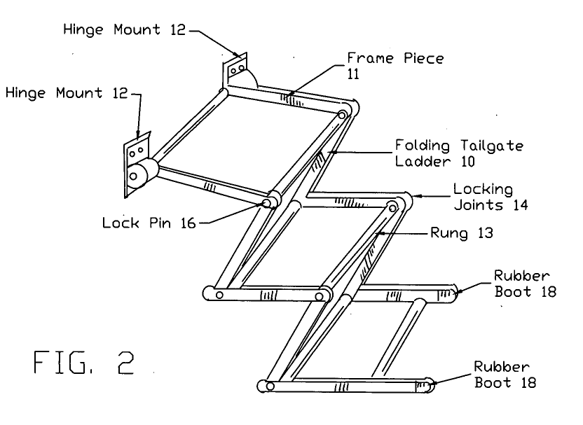

FIG. 2 illustrates a side view of the folding tailgate ladder 10 shown in FIG. 1. In an embodiment, the ladder 10 is configured so that it may be folded up into a box shape approximately 19 inches in height, 11 inches in width, and 10 inches in depth. This configuration allows the folded ladder to fit within the typical area of a pickup tailgate, which is 19 inches in height.

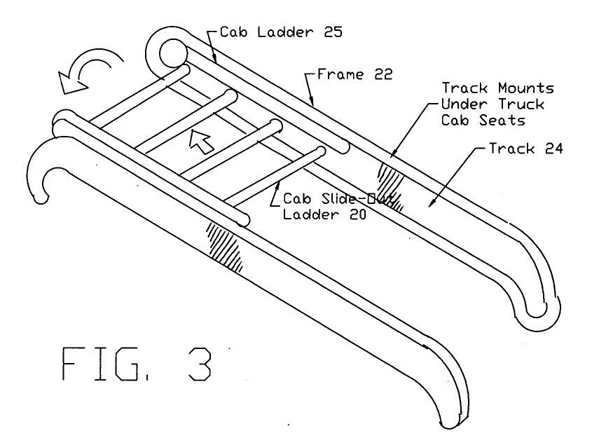

FIG. 3 illustrates a three quarters view of a cab ladder 25 that provides access to the cab of a pickup truck. In an embodiment, the cab ladder 25 is 44 inches in length and 11 inches wide and is placed under a seat approximately 44 inches in length in the cab of the pickup. In other embodiments, the cab ladder 25 may have other dimensions for use with seats of different sizes.

In an embodiment, a metal cab slide-out ladder 20 fits within a two-piece metal frame 22 with tracks 24 and curved ends. When the cab slide-out ladder 20 is extended fully in either direction, the cab slide-out ladder 20 slides around the curved ends of the frame 22, moves into a vertical position outside a door of the pickup, and extends to the ground. Rubber boots 18 on the all four ends of the cab slide-out ladder 20 provide secure traction, when the cab slide-out ladder 20 is slid out either to the left or to the right.

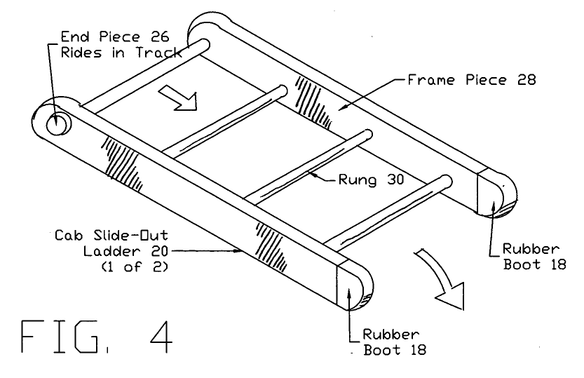

FIG. 4 illustrates a three quarters view of the cab slide-out ladder 20 of the cab ladder 25 shown in FIG. 3. In an embodiment, the frame pieces 28 may comprise metal tubing 2 inches in width and 1 inch in depth. In different embodiments, the frame pieces 28 may be of different lengths, depending on the dimensions of the pickup trucks they are designed to fit. In an embodiment, the rungs 30 may comprise rods 1 inch in diameter and 11 inches in length. Note that the cab slide-out ladder 20 comprises two end pieces 26, on the sides of one end, that are designed to ride in the tracks 24, shown in FIG. 3, of the frame 22 to permit sliding.

In its different embodiments, the present invention thus provides an apparatus for making it easier to get into and out of areas of pickup trucks, and moreover an apparatus that is safe to use, simple in design, comfortable to use, and easy to store and operate.

What is claimed is:

1. An apparatus for making it easier to get into and out of areas of pickup trucks, comprising
a ladder that is adjustable in length; and
rubber boots on one or both ends of the ladder.

2. The ladder of claim 1 wherein the ladder comprises a folding tailgate ladder for getting into and out of the beds of pickup trucks, the folding tailgate ladder comprising
means for attaching the ladder to the tailgate of a pickup truck,
frame pieces,
rungs,
locking joints, and
lock pins.

3. The means for attaching the ladder to the tailgate of a pickup truck of claim 2 wherein the means comprise
two metal hinge mounts,
eight ½ inch, round metal bolts, and
eight square metal nuts ½ inch in height and ½ inch in width.

4. The frame pieces of claim 2 wherein the frame pieces comprise
metal tubing 2 inches in width, 1 inch in depth, and 19 inches in length with rounded ends.

5. The rungs of claim 2 wherein the rungs comprise
metal rods 1 inch in diameter and 11 inches in length with rounded ends.

6. The ladder of claim 1 wherein the ladder comprises a cab ladder that provides access to the cab of a pickup truck, the cab ladder comprising
two frames with tracks and curved on all ends, and
a cab slide-out ladder.

7. The cab slide-out ladder of claim 6 wherein the cab slide-out ladder comprises
frame pieces,
rungs,
four end tips covered with rubber boots, and
two end pieces on the sides of one end.

8. The frame pieces of claim 7 wherein the frame pieces comprise
metal tubing 2 inches in width and 1 inch depth with rounded ends.

9. The rungs of claim 7 wherein the rungs comprise
metal rods 1 inch in diameter and 11 inches in length with rounded ends.

10. A folding tailgate ladder for making it easier to get into and out of the bed area of pickup trucks, comprising
means for attaching the ladder to the tailgate of a pickup truck,
frame pieces,
rungs,
locking joints,
lock pins, and
rubber boots on the two tips of one end of the ladder.

11. The means for attaching the ladder to the tailgate of a pickup truck of claim 10 wherein the means comprise
two metal hinge mounts,
eight ½ inch, round metal bolts, and
eight square metal nuts ½ inch in height and ½ inch in width.

12. The frame pieces of claim 10 wherein the frame pieces comprise
metal tubing 2 inches in width, 1 inch in depth, and 19 inches in length with rounded ends.

13. The rungs of claim 10 wherein the rungs comprise
metal rods 1 inch in diameter and 11 inches in length with rounded ends.

14. A cab ladder for making it easier to get into and out of the cab area of pickup trucks, comprising
two frames with tracks and curved on all ends, and
a cab slide-out ladder.

15. The cab slide-out ladder of claim 14 wherein the cab slide-out ladder comprises
frame pieces,
rungs,
four end tips covered with rubber boots, and
two end pieces on the sides of one end.

16. The frame pieces of claim 15 wherein the frame pieces comprise
metal tubing 2 inches in width and 1 inch in depth with rounded ends.

17. The rungs of claim 15 wherein the rungs comprise
metal rods 1 inch in diameter and 11 inches in length with rounded ends.
